(19) United States
(12) Patent Application Publication
(10) Pub. No.: US 2017/0315518 A1
(43) Pub. Date: Nov. 2, 2017

(54) MODEL PREDICTIVE CONTROL METHOD AND MODEL PREDICTIVE CONTROL APPARATUS

(71) Applicant: KOREA ADVANCED INSTITUTE OF SCIENCE AND TECHNOLOGY, Daejeon (KR)

(72) Inventors: Jun Yong Noh, Daejeon (KR); Joseph S. Shin, Daejeon (KR); Daseong Han, Gyeonggi-do (KR); Haegwang Eom, Daejeon (KR)

(21) Appl. No.: 15/203,677

(22) Filed: Aug. 19, 2016

(30) Foreign Application Priority Data
Apr. 28, 2016 (KR) 10-2016-0052408

(51) Int. Cl. G05B 13/04

(52) U.S. Cl. CPC G05B 13/048

(57) ABSTRACT

Disclosed is a model predictive control. The model predictive control method includes: receiving an input system dynamics model for a character; performing numerical differentiation to the input system dynamics model by using at least one technique selected from the group consisting of a differentiation information interpolation technique, a physical quantity reuse technique and a contact-space inverse mass matrix (CIMM) technique; and outputting differentiation information for the system dynamics model.

### CROSS-REFERENCE TO RELATED APPLICATION

This application claims priority of Korean Patent Application No. 10-2016-0052408, filed on Apr. 28, 2016, in the KIPO (Korean Intellectual Property Office), the disclosure of which is incorporated herein entirely by reference.

### BACKGROUND OF THE INVENTION

### Field of the Invention

This disclosure relates to a model predictive control method and a model predictive control apparatus, and more particularly, to a model predictive control method and a model predictive control apparatus, based on data using relaxed contact dynamics based on iterative Linear Quadratic Gaussian (iLQG).

### Description of the Related Art

Recently, for model predictive control of an articulated body having a high degree of freedom like a virtual character of a human shape or a humanoid, a model predictive control method based on relaxed contact dynamics, which is relaxed to numerically differentiate contact dynamics between rigid bodies, is used.

In addition, as an optimization technique for model predictive control, there has been used iterative Linear Quadratic Gaussian (iLQG) for solving an optimal control problem by means of first-order and second-order differentiations of an objective function and dynamic programming based on first-order differentiation information of the system dynamics to be controlled.

In addition, as an algorithm for calculating dynamics of an articulated body, an articulated body dynamics algorithm of Featherstone for calculating dynamics of an articulated body on the basis of spatial vector algebra has been used.

However, an existing model predictive control method recently used does not have a long prediction interval doe to high calculation costs, and produced motions are not natural.

Therefore, this disclosure is directed to providing a model predictive control method and a model predictive control apparatus for performing numerical differentiation, which may have an improved speed for the numerical differentiation with respect to a system dynamics model used for iLQG-based model predictive control.

### SUMMARY OF THE INVENTION

In one general aspect of the present disclosure, there is provided a model predictive control method, comprising: receiving an input system dynamics model for a character; performing numerical differentiation to the input system dynamics model by using at least one technique selected from the group consisting of a differentiation information interpolation technique, a physical quantity reuse technique and a contact-space inverse mass matrix (CIMM) technique; and outputting differentiation information for the system dynamics model.

Here, the differentiation information interpolation technique may calculate differentiation information at another time point by interpolating differentiation information calculated at a key time point in a prediction interval with respect to a state change of the input system dynamics model.

In addition, the physical quantity reuse technique may reuse a physical quantity of a present condition when a physical quantity of an articulated body is calculated at a point adjacent to a point where the differentiation is performed, at a key time point in a prediction interval with respect to a state change of the input system dynamics model.

Moreover, the contact-space inverse mass matrix (CIMM) technique may calculate a CIMM by using a Jacobian sparsity preserving property for a contact point, when calculating a CIMM for a mass matrix.

Meanwhile, in another aspect of the present disclosure, there is provided a model predictive control apparatus, comprising: an input unit configured to receive an input system dynamics model for a character; a control unit configured to perform numerical differentiation to the input system dynamics model by using at least one technique selected from the group consisting of a differentiation information interpolation technique, a physical quantity reuse technique and a contact-space inverse mass matrix (CIMM) technique; and an output unit configured to output differentiation information for the system dynamics model.

According to various embodiments of the present disclosure as described above, by using a technique for improving a speed of numerical differentiation used for model predictive control, a model predictive motion may be rapidly and naturally produced.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a flowchart for illustrating a model predictive control method according to an embodiment of the present disclosure.

FIG. 2 is a block diagram showing a model predictive control apparatus according to an embodiment of the present disclosure.

FIG. 3 is a diagram showing a model predictive control system according to an embodiment of the present disclosure.

FIG. 4 is a diagram for illustrating a simulation result obtained by applying the model predictive control method according to an embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

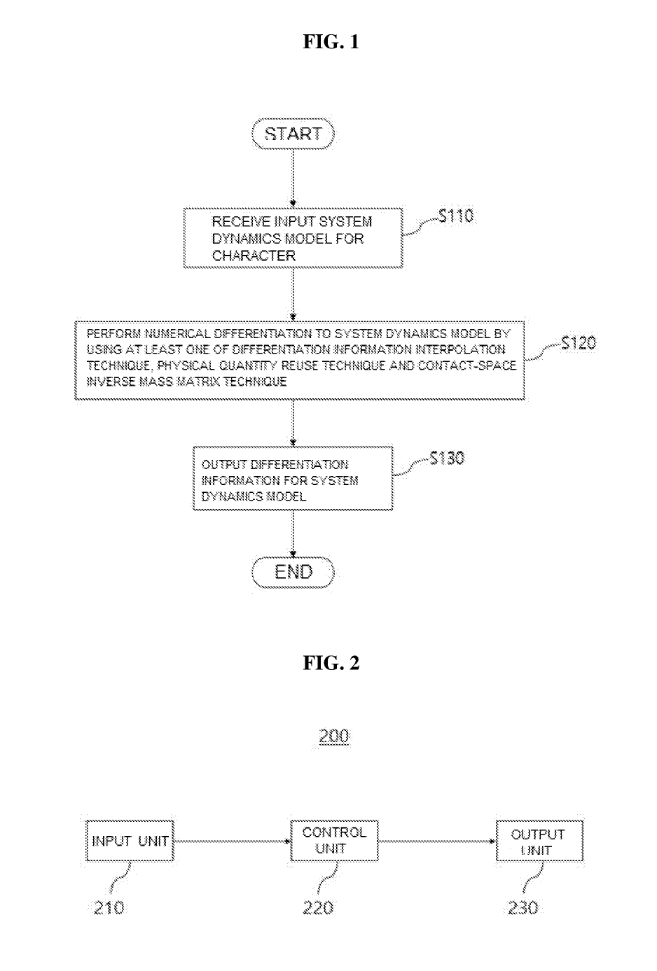

FIG. 1 is a flowchart for illustrating a model predictive control method according to an embodiment of the present disclosure.

Referring to FIG. 1, a model predictive control method according to an embodiment of the present disclosure receives an input system dynamics model for a character (S110), and performs numerical differentiation to the input system dynamics model by using at least one technique selected from the group consisting of a differentiation information interpolation technique, a physical quantity reuse technique and a contact-space inverse mass matrix (CIMM) technique (S120). After that, differentiation information for the system dynamics model is output (S130).

In detail, the differentiation information interpolation technique may calculate differentiation information at another time point by interpolating differentiation information calculated at a key time point in a prediction interval with respect to a state change of the input system dynamics model. The physical quantity reuse technique may reuse a physical quantity of a present condition when a physical quantity of an articulated body is calculated at a point adjacent to a point where the differentiation is performed, at a key time point in a prediction interval with respect to a state change of the input system dynamics model. When calculating a CIMM for a mass matrix, the contact-space inverse mass matrix (CIMM) technique may calculate a CIMM by using a Jacobian sparsity preserving property for a contact point. Here, the CIMM for a mass matrix may be calculated based on LTDL decomposition for the mass matrix.

In addition, in the model predictive control method according to an embodiment of the present disclosure, motion capture data may be applied to the model predictive control so that natural motions are produced. In detail, an optimization problem may be standardize so that contact force or contact time is not explicitly used as an optimization variable, and thus the contact point or contact time may be freely changed depending on a current state of a character or humanoid.

In addition, the model predictive control method according to an embodiment of the present disclosure may be applied to improve a speed in relation to various trajectory optimization problems of an articulated body (for example, a technique of controlling a robot arm, a technique of producing a motion without example data, or the like). Moreover, a produced motion may be guided by means of motion capture data while freely changing a contact point or contact time, in order to produce a natural motion robust to external force or environmental change.

FIG. 2 is a block diagram showing a model predictive control apparatus according to an embodiment of the present disclosure.

Referring to FIG. 2, a model predictive control apparatus 200 according to an embodiment of the present disclosure includes an input unit 210, a control unit 220 and an output unit 230.

The input unit 210 receives an input system dynamics model for a character. If the system dynamics model is input to the input unit 210, the control unit 220 may perform numerical differentiation to the input system dynamics model by using at least one technique selected from the group consisting of a differentiation information interpolation technique, a physical quantity reuse technique and a contact-space inverse mass matrix (CIMM) technique. After that, the output unit 230 outputs differentiation information for the system dynamics model calculated by numerical differentiation.

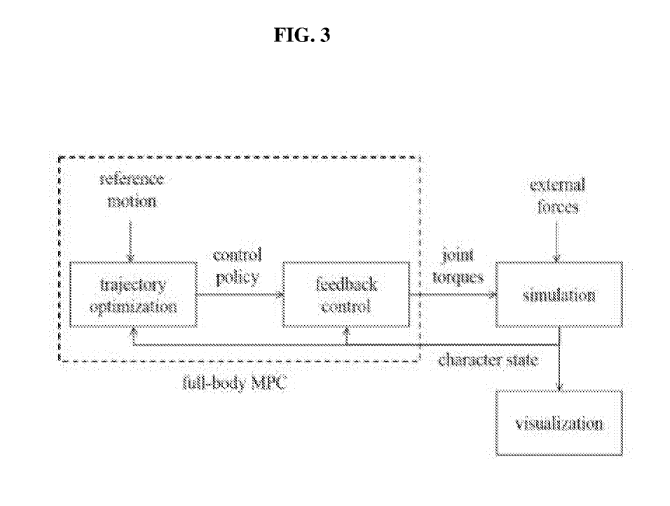

FIG. 3 is a diagram showing a model predictive control system according to an embodiment of the present disclosure.

Referring to FIG. 3, if a reference motion for a character is input, trajectory optimization is performed, and a feedback control is performed by means of a control policy. After that, simulation may be performed by means of joint torques and external forces, thereby ensuring visualization.

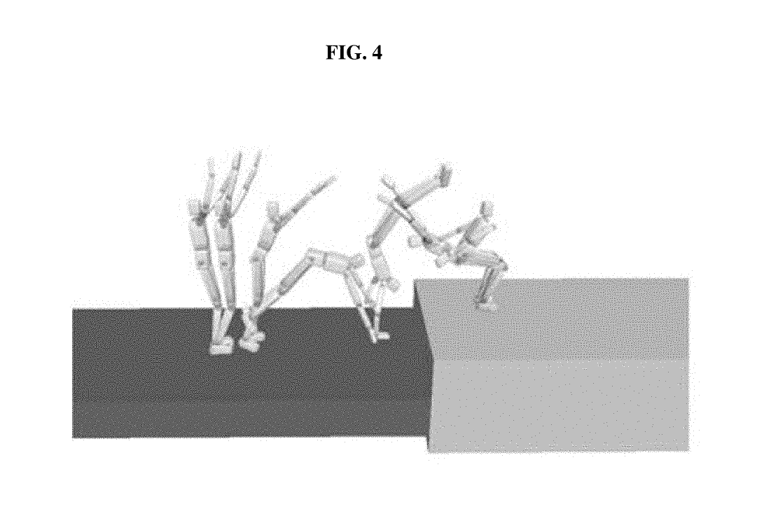

FIG. 4 is a diagram for illustrating a simulation result obtained by applying the model predictive control method according to an embodiment of the present disclosure.

Referring to FIG. 4, it may be found that when a character performs a backflip motion, the motion of the character is naturally produced by applying the model predictive control method according to an embodiment of the present disclosure.

According to various embodiments of the present disclosure as described above, by using a technique for improving a speed of numerical differentiation used for model predictive control, a model predictive motion may be rapidly and naturally produced.

Meanwhile, the method according to various embodiments of the present disclosure as described above may be implemented as program codes stored in various non-transitory computer readable media and may be provided to each server or device in this state.

The non-transitory computer readable medium means a medium which may store data semi-permanently and be read by a device, rather than a medium storing data within a short time like register, cash, memory or the like. In detail, the various applications or programs described above may be provided in a state of being stored in a non-transitory computer readable medium such as CD, DVD, hard-disk, bleu-ray disk, USB, memory card, ROM or the like.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A model predictive control method comprising:
receiving an input system dynamics model for a character;
performing numerical differentiation to the input system dynamics model by using at least one technique selected from the group consisting of a differentiation information interpolation technique, a physical quantity reuse technique and a contact-space inverse mass matrix (CIMM) technique; and
outputting differentiation information for the system dynamics model.

2. The model predictive control method of claim 1, wherein the differentiation information interpolation technique calculates differentiation information at another time point by interpolating differentiation information calculated at a key time point in a prediction interval with respect to a state change of the input system dynamics model.

3. The model predictive control method of claim 1, wherein the physical quantity reuse technique reuses a physical quantity of a present condition when a physical quantity of an articulated body is calculated at a point adjacent to a point where the differentiation is performed, at a key time point in a prediction interval with respect to a state change of the input system dynamics model.

4. The model predictive control method of claim 1, wherein the contact-space inverse mass matrix (CIMM) technique calculates a CIMM by using a Jacobian sparsity preserving property for a contact point, when calculating a CIMM for a mass matrix.

5. A model predictive control apparatus comprising:
an input unit configured to receive an input system dynamics model for a character;
a control unit configured to perform numerical differentiation to the input system dynamics model by using at least one technique selected from the group consisting of a differentiation information interpolation technique, a physical quantity reuse technique and a contact-space inverse mass matrix (CIMM) technique; and
an output unit configured to output differentiation information for the system dynamics model.

6. The model predictive control apparatus of claim 5, wherein the differentiation information interpolation technique calculates differentiation information at another time point by interpolating differentiation information calculated at a key time point in a prediction interval with respect to a state change of the input system dynamics model.

7. The model predictive control apparatus of claim 5, wherein the physical quantity reuse technique reuses a physical quantity of a present condition when a physical quantity of an articulated body is calculated at a point adjacent to a point where the differentiation is performed, at a key time point in a prediction interval with respect to a state change of the input system dynamics model.

8. The model predictive control method of claim 5, wherein the contact-space inverse mass matrix (CIMM) technique calculates a CIMM by using a Jacobian sparsity preserving property for a contact point, when calculating a CIMM for a mass matrix.
